(19) United States
(12) Patent Application Publication
(10) Pub. No.: US 2019/0344436 A1
(43) Pub. Date: Nov. 14, 2019

(54) TRANSFERRING SYSTEM AND METHOD OF OPERATING THE SAME

(71) Applicant: KAWASAKI JUKOGYO KABUSHIKI KAISHA, Kobe-shi, Hyogo (JP)

(72) Inventors: Yasuhiko HASHIMOTO, Kobe-shi (JP); Kenji BANDO, Nishinomiya-shi (JP); Kazunori HIRATA, Yao-shi (JP)

(73) Assignee: KAWASAKI JUKOGYO KABUSHIKI KAISHA, Kobe-shi, Hyogo (JP)

(21) Appl. No.: 16/482,208

(22) PCT Filed: Jan. 26, 2018
(86) PCT No.: PCT/JP2018/002437

§ 371 Date: Jul. 30, 2019

(30) Foreign Application Priority Data
Jan. 30, 2017 (JP) 2017-014115

(51) Int. Cl. B25J 9/00; B25J 9/16

(52) U.S. Cl. CPC B25J 9/0087; B25J 9/1664

(57) ABSTRACT

A transferring system includes a robot including a first arm having a first grip part and a second arm having a second grip part, a transferring device including a pair of to-be-gripped parts a pair of holding parts configured to hold a workpiece, and an elevator configured to ascend and descend the holding part, and a control device configured to control the robot and the transferring device. The control device operates the elevator so that the to-be-gripped parts move to a first position that is a position at which the first grip part or the second grip part is able to grip the to-be-gripped part, when causing the pair of holding parts to hold the workpiece.

### TECHNICAL FIELD

The present disclosure relates to a transferring system and a method of operating the same.

### BACKGROUND ART

Methods of transferring a workpiece to a given position are known (for example, refer to Patent Document 1). The transferring method disclosed in the Patent Document 1 includes providing a balancer to a robot side by side, and gripping a workpiece by the balancer, gripping a seat (to-be-gripped part) of the balancer by the robot, and moving the balancer to transfer the workpiece.

### REFERENCE DOCUMENT OF CONVENTIONAL ART

### Patent Document

[Patent Document 1] JP1997-001492A

### DESCRIPTION OF THE DISCLOSURE

### Problem to be Solved by the Disclosure

However, in the transferring method disclosed in the Patent Document 1, since the balancer cannot operate (move) by itself, for example, when the robot performs a work to the workpiece before and after transferring the workpiece, the robot needs to move the balancer to evacuate so that the balancer does not interfere with the work. Therefore, when the robot performs the work to the workpiece before and after transferring the workpiece, there is a problem that it takes time before the robot starts the work.

The present disclosure is made in view of solving the conventional problem, and one purpose thereof is to provide a transferring system and a method of operating the same in which a robot and a transferring device which collaboratively transfer a workpiece, with a shortened time before the robot starts a work to the workpiece, by a simple configuration.

### Summary of the Disclosure

In order to solve the conventional problem, a transferring system according to one aspect of the present disclosure includes a robot including a first arm having a first grip part and a second arm having a second grip part, a transferring device including a pair of to-be-gripped parts, a pair of holding parts configured to hold a workpiece, and an elevator configured to ascend and descend the holding part, and a control device configured to control the robot and the transferring device. The control device operates the elevator so that the to-be-gripped parts move to a first position that is a position at which the first grip part or the second grip part is able to grip the to-be-gripped parts, when causing the pair of holding parts to hold the workpiece.

Thus, when causing the pair of holding parts to hold the workpiece, since the elevator automatically moves (lowers) the to-be-gripped parts to the first position, the time before the robot starts the work to the workpiece can be shortened.

Further, a method of operating a transferring system according to another aspect of the present disclosure is a method of operating a transferring system provided with a robot including a first arm having a first grip part and a second arm having a second grip part. The transferring system is further provided with a transferring device including a pair of to-be-gripped parts, a pair of holding parts configured to hold a workpiece, and an elevator configured to ascend and descend the holding parts. The method includes the steps of (A) operating the elevator so that the to-be-gripped parts move from a first position that is an evacuating position of the to-be-gripped part to a second position that is a position at which one of the first grip part and the second grip part is able to grip the to-be-gripped part.

Thus, when causing the pair of holding parts to hold the workpiece, since the elevator automatically moves (lowers) the to-be-gripped parts to the first position, the time before the robot starts the work to the workpiece can be shortened.

The above purpose, other purposes, features, and advantages of the present disclosure will be made clear from the following detailed description of a suitable embodiment with reference to the accompanying drawings.

### Effect of the Disclosure

According to the transferring system and the method of operating the same of the present disclosure, when the workpiece is held by the pair of holding parts, since the elevator automatically moves (lowers) the to-be-gripped part to the first position, the time before the robot starts the work to the workpiece can be shortened.

### BRIEF DESCRIPTION OF DRAWINGS

FIG. 1 is a perspective view illustrating an outline configuration of a transferring system according to Embodiment 1.

FIG. 2 is a schematic view illustrating an outline configuration of a robot in the transferring system illustrated in FIG. 1.

FIG. 3 is a functional block diagram schematically illustrating a configuration of a control device of the robot illustrated in FIG. 2.

FIG. 4 is a schematic view illustrating an outline configuration of an upper surface of a first hand part of the robot illustrated in FIG. 2.

FIG. 5 is a schematic view illustrating an outline structure of a transferring device (first unit) in the transferring system illustrated in FIG. 1.

FIG. 6 is a flowchart illustrating one example of operation of the transferring system according to Embodiment 1.

FIG. 7 is a schematic view illustrating a state of the robot and the transferring device when the transferring system operates according to the flowchart illustrated in FIG. 6.

FIG. 8 is a schematic view illustrating a state of the robot and the transferring device when the transferring system operates according to the flowchart illustrated in FIG. 6.

FIG. 9 is a schematic view illustrating a state of the robot and the transferring device when the transferring system operates according to the flowchart illustrated in FIG. 6.

FIG. 10 is a schematic view illustrating a state of the robot and the transferring device when the transferring system operates according to the flowchart illustrated in FIG. 6.

FIG. 11A is a flowchart illustrating another example of the operation of the transferring system according to Embodiment 1.

FIG. 11B is a flowchart illustrating another example of the operation of the transferring system according to Embodiment 1.

FIG. 12 is a schematic view illustrating a state of the robot and the transferring device when the transferring system operates according to the flowchart illustrated in FIGS. 11A and 11B.

FIG. 13 is a schematic view illustrating a state of the robot and the transferring device when the transferring system operates according to the flowchart illustrated in FIGS. 11A and 11B.

FIG. 14 is a schematic view illustrating a state of the robot and the transferring device when the transferring system operates according to the flowchart illustrated in FIGS. 11A and 11B.

### MODE FOR CARRYING OUT THE DISCLOSURE

Hereinafter, one embodiment of the present disclosure will be described with reference to the drawings. Note that, throughout the drawings, the same reference characters are given to the same or corresponding components to omit redundant description. Moreover, throughout the drawings, the components illustrating the present disclosure are selectively illustrated, and illustration of other components may be omitted. Further, the present disclosure is not limited to the following embodiment.

### Embodiment 1

The transferring system according to Embodiment 1 includes a robot, a transferring device, and a control device. The robot includes a first arm having a first grip part, and a second arm having a second grip part. The transferring device includes a pair of to-be-gripped parts, a pair of holding parts which hold a workpiece, an elevator which ascends and descends the holding part. The control device controls the robot and the transferring device. The control device causes the elevator to operate, when causing the pair of holding parts to hold the workpiece, so that the to-be-gripped parts move to a first position that is a position at which the first grip part or the second grip part is able to grip the to-be-gripped part.

Moreover, in the transferring system according to Embodiment 1, the control device may operate the robot so that the first grip part grips one of the to-be-gripped parts and the second grip part grips the other grip part, and may then operate the robot so that the pair of holding parts hold and transfer the workpiece.

Moreover, in the transferring system according to Embodiment 1, the control device may operate the robot so that the pair of holding parts move so as to oppose to each other on both sides of the workpiece, and the holding parts then scoop up the workpiece.

Further, in the transferring system according to Embodiment 1, the control device may operate the robot so that, after the workpiece is transferred, the hold of the to-be-gripped parts is released, and may then operate the elevator so that the to-be-gripped parts move to a second position that is an evacuating position of the to-be-gripped part.

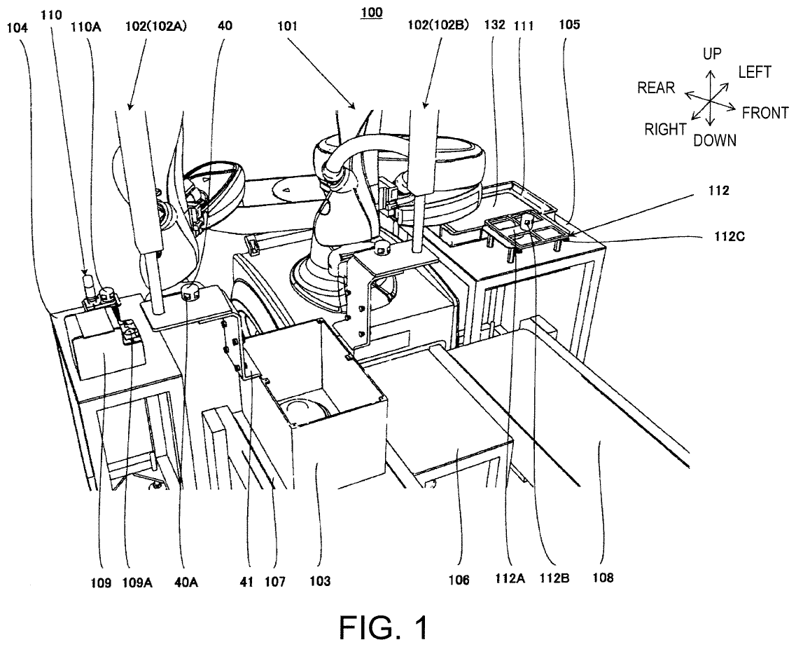

Hereinafter, one example of the transferring system according to Embodiment 1 is described with reference to FIGS. 1 to 14.

### Configuration of Transferring System

FIG. 1 is a perspective view illustrating an outline configuration of the transferring system according to Embodiment 1.

Note that, in FIG. 1, a front-and-rear direction, an up-and-down direction, and a left-and-right direction of a robot in the transferring system are expressed as a front-and-rear direction, an up-and-down direction, and a left-and-right direction in this figure, respectively.

As illustrated in FIG. 1, a transferring system 100 according to Embodiment 1 includes a robot 101 and a transferring device 102. The robot 101 and the transferring device 102 collaboratively transfer a workpiece 103. Moreover, the transferring device 102 has a first unit 102A and a second unit 102B, and a holding part 41 of the first unit 102A and a holding part 41 of the second unit 102B hold the workpiece 103 by scooping up the workpiece 103. Note that, in Embodiment 1, the workpiece 103 may be, for example, the workpiece with large weight, and may be a speaker.

First, a configuration of each apparatus disposed in a workspace where the transferring system 100 according to Embodiment 1 performs a work is described with reference to FIG. 1.

As illustrated in FIG. 1, in the workspace where the transferring system 100 according to Embodiment 1 performs the work, a first table 104, a second table 105, a workbench 106, a first belt conveyor 107, and a second belt conveyor 108 are placed.

A screw feeder 109 which automatically feeds a screw 109A and a screwdriver 110 are placed on the first table 104. A known screw feeder may be used as the screw feeder 109. For example, an electric screwdriver may be used as the screwdriver 110. Moreover, the screwdriver 110 is provided with a to-be-gripped part 110A. The to-be-gripped part 110A is formed in a substantially cylindrical shape, and two recesses are formed in a circumferential surface thereof Tip-end parts of pawl portions 10A of a first arm 13A of the robot 101 contact the recesses as will be described later. Thus, the first arm 13A can grip the to-be-gripped part 110A firmly.

A lid member 132 accommodated in a tray 111, a suction member 112 which sucks and holds the lid member 132, are placed on the second table 105.

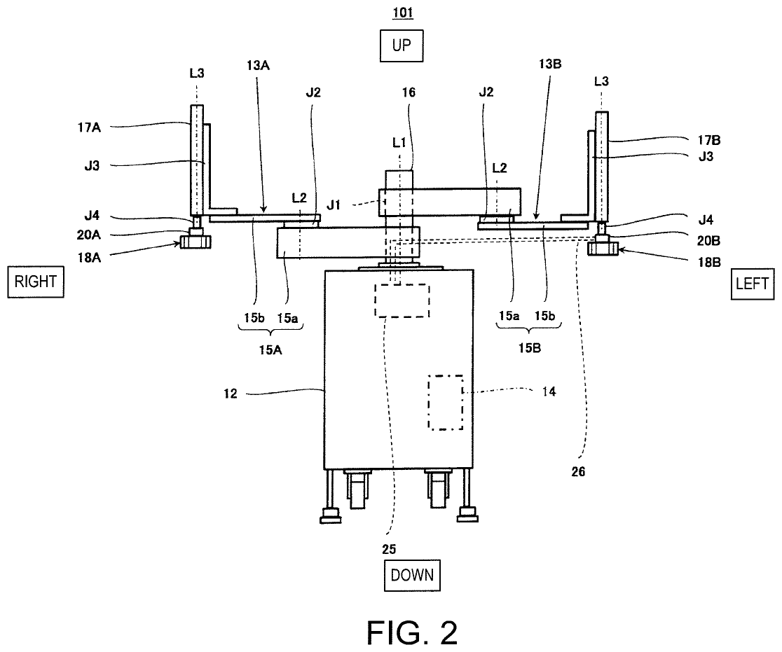

The suction member 112 has a first plate member 112A, a to-be-gripped part 112B, and a suction part 112C. By a second arm 13B (described later) of the robot 101 gripping the to-be-gripped part 112B, the suction part 112C is connected with a vacuum generator 25 of the robot 101 through piping 26 (refer to FIG. 2).

The first plate member 112A is formed with an opening in a principal surface thereof, and the to-be-gripped part 112B is provided to an upper surface. The to-be-gripped part 112B is formed in a substantially cylindrical shape, and two recesses are formed in a circumferential surface thereof Tip-end parts of pawl portions 10B of the second arm 13B of the robot 101 contact the recesses as will be described later. Thus, the second arm 13B can grip the to-be-gripped part 112B firmly.

Moreover, the suction part 112C is provided to a lower surface of the first plate member 112A. The suction part 112C is vacuumed by the vacuum generator 25 to be a negative pressure inside thereof, and it can suck and hold the lid member 132.

The first belt conveyor 107 conveys the workpiece 103 to a location in front of the robot 101. Moreover, the workpiece 103 conveyed on the first belt conveyor 107 is placed on the workbench 106. The workpiece 103 to which a given work is performed is placed on the second belt conveyor 108, and the second belt conveyor 108 conveys the workpiece 103 to a work place where the following process is performed.

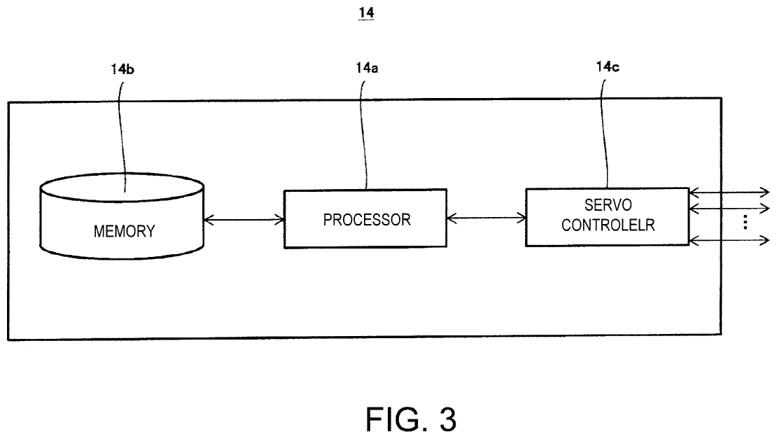

Next, a concrete configuration of the robot 101 is described with reference to FIGS. 2 and 3. Note that, in the following, although a horizontal articulated dual-arm robot is described as the robot 101, other robots, such as of a horizontal articulated or vertical articulated type may be adopted as the robot 101.

FIG. 2 is a schematic view illustrating an outline configuration of the robot in the transferring system illustrated in FIG. 1. FIG. 3 is a functional block diagram schematically illustrating a configuration of a control device of the robot illustrated in FIG. 2. Note that, in FIG. 2, the up-and-down direction and left-and-right direction of the robot are expressed as an up-and-down direction and a left-and-right direction in this figure, respectively.

As illustrated in FIG. 2, the robot 101 includes a carrier 12, the first arm 13A, the second arm 13B, and a control device 14 and the vacuum generator 25 which are disposed inside the carrier 12. The control device 14 controls the first arm 13A, the second arm 13B, the vacuum generator 25, and the transferring device 102. Note that, in Embodiment 1, although the control device 14 and the vacuum generator 25 are disposed inside the carrier 12, these apparatuses may be disposed outside the carrier 12, without being limited to this structure.

A base shaft 16 is fixed to an upper surface of the carrier 12. The base shaft 16 is provided with the first arm 13A and the second arm 13B so as to be rotatable on a rotation axis L1 which passes through the axial center of the base shaft 16. Specifically, the first arm 13A and the second arm 13B are provided so as to have a height difference therebetween. Note that the first arm 13A and the second arm 13B can operate independently or dependently.

The first arm 13A includes a first arm part 15A, a first wrist part 17A, a first hand part 18A, and a first attaching part 20A. Similarly, the second arm 13B includes a second arm part 15B, a second wrist part 15B, a second hand part 18B, and a second attaching part 20B. Note that, since the fundamental structure of the second arm 13B is similar to that of the first arm 13A, the detailed description thereof is omitted.

In Embodiment 1, the first arm part 15A is comprised of a first link 5a and a second link 5b, each having a substantially rectangular parallelepiped shape. The first link 5a is provided at a base-end part with a rotary joint J1, and provided at a tip-end part with a rotary joint J2. Moreover, the second link 5b is provided at a tip-end part with a linear-motion joint J3.

The first link 5a is coupled at a base-end part to the base shaft 16 through the rotary joint J1, and is rotatable on the rotation axis L1 by the rotary joint J1. Moreover, the second link 5b is coupled at a base-end part to the tip-end part of the first link 5a through the rotary joint J2, and is rotatable on the rotation axis L2 by the rotary joint J2.

The second link 5b is coupled at a tip-end part to the first wrist part 17A through the linear-motion joint J3, and is ascendable and descendable with respect to the second link 5b. A rotary joint J4 is provided to a lower end part of the first wrist part 17A, and the first attaching part 20A is provided to a lower end part of the rotary joint J4.

The first attaching part 20A is attachable and detachable of the first hand part 18A. Specifically, for example, the first attaching part 20A has a pair of bar members which is adjustable of an interval therebetween, and by pinching the first hand part 18A with the pair of bar members, the first hand part 18A can be attached to the first wrist part 17A. Thus, the first hand part 18A is rotatable on the rotation axis L3 by the rotary joint J4. Note that tip-end portions of the bar members may be bent or curved.

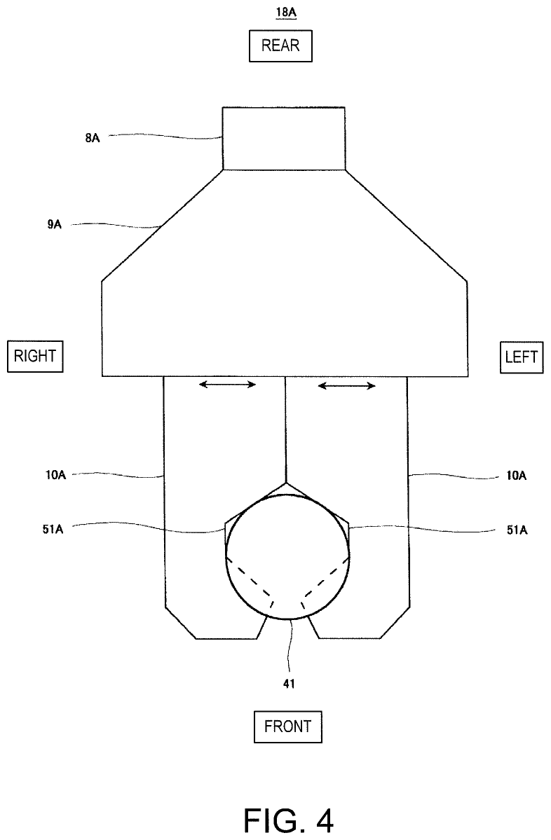

Here, with reference to FIG. 4, the first hand part 18A of the first arm 13A is described in detail.

FIG. 4 is a schematic view illustrating an outline configuration of an upper surface of the first hand part of the robot illustrated in FIG. 2. Note that, in FIG. 4, the front-and-rear direction and left-and-right direction of the robot (first hand part) are expressed as a front-and-rear direction and a left-and-right direction in this figure, respectively.

As illustrated in FIG. 4, the first hand part 18A of the first arm 13A includes a stationary portion 8A, a main body portion 9A, and the pair of pawl portions 10A. The first hand part 18A is constructed so that the pair of pawl portions 10A contact an outer circumferential surface of a to-be-gripped part 40 described later (refer to FIG. 1) of the transferring device 102 to grip the to-be-gripped part 40. Note that, in Embodiment 1, the pawl portions 10A constitute the first grip part. Moreover, the pawl portions 10B of the second hand part 18B of the second arm 13B constitute the second grip part.

The stationary portion 8A is a part to which the first attaching part 20A contacts, and is formed in a plate shape, here. Moreover, a tip-end part of the main body portion 9A is provided with the pair of pawl portions 10A. A first contact surface 51A which contacts the outer circumferential surface of the to-be-gripped part 40 is formed in an inner circumferential surface of each pawl portion 10A. Note that the first contact surface 51A on the tip-end part side of the pawl portion 10A contacts the recess 40A (refer to FIG. 1) of the to-be-gripped part 40 to grip the to-be-gripped part 40 firmly.

Here, the first contact surface 51A is formed in a substantially trapezoid shape when seen in the up-and-down direction, and the pair of pawl portions 10A are formed in a substantially hexagon shape as a whole. Moreover, at least one of the pawl portions 10A is movable in the left-and-right direction by an actuator (not illustrated).

Note that the first contact surface 51A may be formed in a polygon, such as a quadrangle, or may be formed in a circle, or may be formed in a flat plate shape. Moreover, an elastic member, such as rubber, may be disposed on the first contact surface 51A.

Moreover, each of the joints J1-J4 of the first arm 13A and the second arm 13B is provided with a drive motor (not illustrated) as one example of an actuator relatively rotates, or ascends and descends two members coupled through the joint. The drive motor may be, for example, a servo motor which is servo-controlled by the control device 14. Moreover, each of the joints J1-J4 is provided with a rotation sensor (not illustrated) which detects a rotational position of the drive motor, a current sensor (not illustrated) which detects current which controls the rotation of the drive motor. The rotation sensor may be, for example, an encoder.

As illustrated in FIG. 3, the control device 14 includes a processor 14a, such as a CPU, a memory 14b, such as a ROM and/or a RAM, and a servo controller 14c. The control device 14 is, for example, a robot controller provided with a computer, such as a microcontroller.

Note that the control device 14 may be comprised of a sole control device 14 which carries out a centralized control of the robot 101 and the transferring device 102, or may be comprised of a plurality of control devices 14 which collaboratively carry out a distributed control of the robot 101 and the transferring device 102. If carrying out the distributed control of the robot 101 and the transferring device 102 by the plurality of control devices 14, each of the plurality of control devices 14 may control both the robot 101 and the transferring device 102.

Moreover, in Embodiment 1, although the memory 14b is disposed inside the control device 14, the memory 14b may be provided separately from the control device 14, without being limited to the structure.

The memory 14b stores information on a basic program as the robot controller, various fixed data, etc. The processor 14a controls various operations of the robot 101 and the transferring device 102 by reading and executing software, such as the basic program stored in the memory 14b.

The vacuum generator 25 is a device which vacuums the inside of the suction part 112C of the suction member 112 to a negative pressure, and may be, for example, a vacuum pump or CONVUM®. An on-off valve (not illustrated) is provided to piping 26. By the on-off valve opening or closing the piping 26, suction and release of the lid member 132 are performed by the suction part 112C. Note that the operation of the vacuum generator 25 and the opening and closing of the on-off valve are controlled by the control device 14.

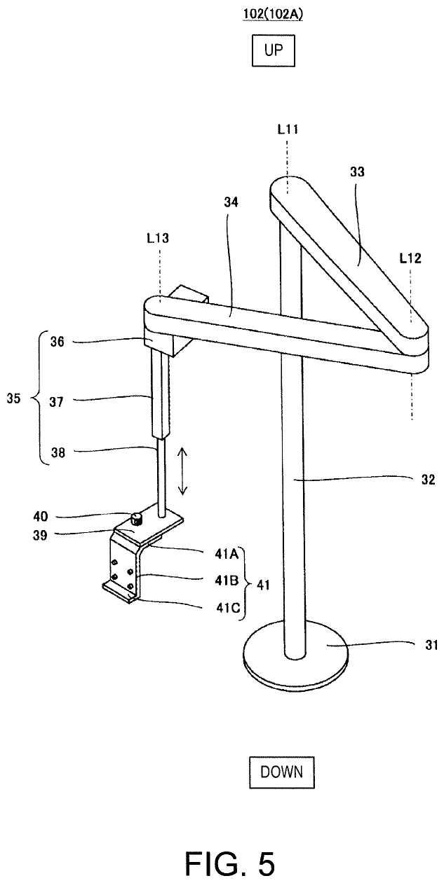

Next, a structure of the transferring device 102 in the transferring system 100 according to Embodiment 1 is described with reference to FIG. 5.

FIG. 5 is a schematic view illustrating an outline structure of the transferring device (first unit) in the transferring system illustrated in FIG. 1. Note that, in FIG. 5, the up-and-down direction of the transferring device (first unit) is expressed as an up-and-down direction in this figure. Moreover, since the second unit 102B is constructed similar to the first unit 102A, the detailed description thereof is omitted.

As illustrated in FIG. 5, the first unit 102A includes a pedestal 31, a pillar member 32, a first arm 33, a second arm 34, an elevator 35, a to-be-gripped part 40, and a holding part 41. The pedestal 31 is fixed to a floor or underframe, and the pillar member 32 is provided so as to stand from the pedestal 31. Note that, in Embodiment 1, although the pedestal 31 is fixed to the floor etc., it may be movable by wheels etc., without being limited to the structure.

A base-end part of the first arm 33 is provided to an upper end part of the pillar member 32 rotatably on a rotation axis L11. Moreover, a base-end part of the second arm 34 is provided to a tip-end part of the first arm 33 rotatably on a rotation axis L12. The elevator 35 is provided to a tip-end part of the second arm 34.

The elevator 35 raises and lowers the to-be-gripped part 40 and the holding part 41. For example a linear-motion actuator or an air cylinder may be used as the elevator 35. In Embodiment 1, the elevator 35 is comprised of the linear-motion actuator, and it has a first casing 36 which accommodates a drive motor (servo motor; not illustrated), and a second casing 37 which accommodates a threaded shaft (not illustrated) of a ball screw mechanism, and a third casing 38 which accommodates a nut assembly.

Note that, the first casing 36 is provided with a rotation sensor (not illustrated) which detects a rotational position of the drive motor, a current sensor (not illustrated) which detects current for controlling the rotation of the drive motor. The rotation sensor may be, for example an encoder.

The drive of the elevator 35 is controlled by the processor 14a of the control device 14 reading and executing software, such as the basic program stored in the memory 14b.

A plate member 39 is fixedly provided to a tip-end part (lower end part) of the third casing 38. The cylindrical to-be-gripped part 40 is provided to an upper surface of the plate member 39. Two recesses 40A are formed in a circumferential surface of the to-be-gripped part 40. As described above, the tip-end parts of the pawl portions 10A the first arm 13A of the robot 101 contact the recesses 40A. Thus, the first arm 13A can grip the to-be-gripped part 40 firmly.

A holding part 41 is fixedly provided to a lower surface of the plate member 39. The holding part 41 is formed in a substantially S-shape. The holding part 41 has a plate-shaped first portion 41A disposed in an upper part and extending horizontally, a plate-shaped third portion 41C disposed in a lower part and extending horizontally, and a plate-shaped second portion 41B connecting these plate-shaped portions and extending in the up-and-down direction. An upper surface of the third portion 41C forms a placement surface where the workpiece 103 is placed. Moreover, a tip-end part of the third portion 41C may be formed so that the thickness becomes smaller as it goes toward the tip end.

### Operation and Effects of Transferring System

Next, operation and effects of the transferring system 100 according to Embodiment 1 are described with reference to FIGS. 1 to 14. Note that the following operation is performed by the processor 14a of the control device 14 reading the program stored in the memory 14b.

First, operation of the robot 101 and the transferring device 102 collaboratively transferring (placing) the workpiece 103 conveyed from the first belt conveyor 107 onto the workbench 106 is described with reference to FIGS. 1 to 10.

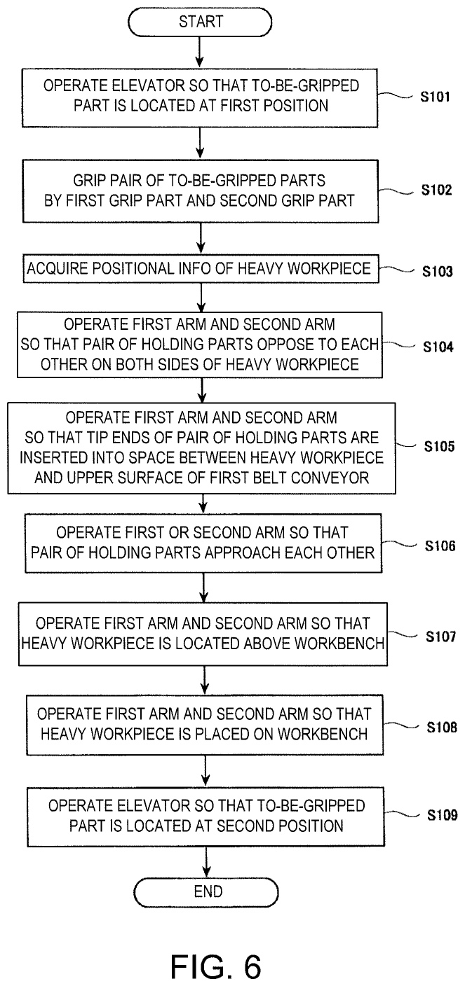

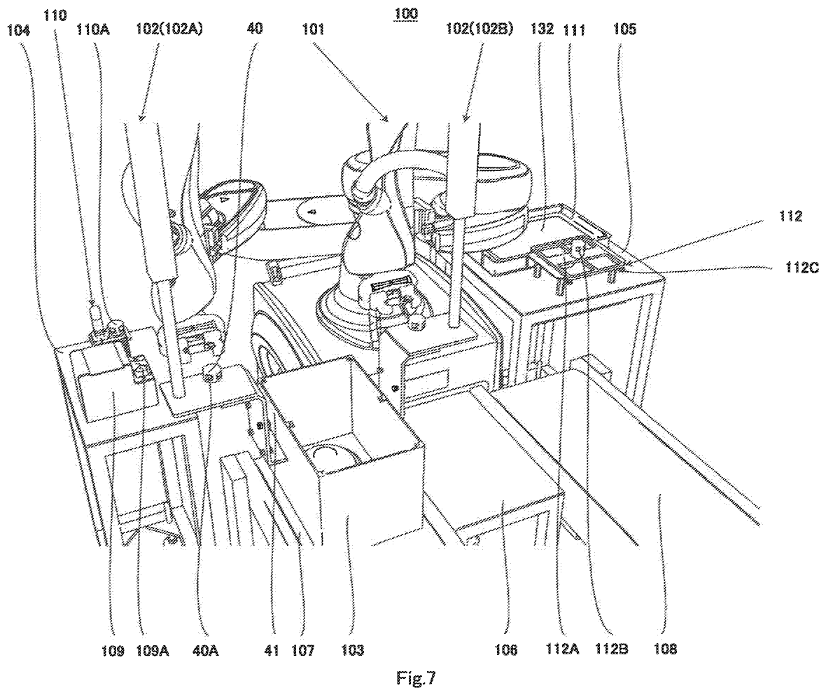

FIG. 6 is a flowchart illustrating one example of operation of the transferring system according to Embodiment 1. FIGS. 7 to 10 are schematic views illustrating states of the robot and the transferring device when the transferring system operates according to the flowchart illustrated in FIG. 6.

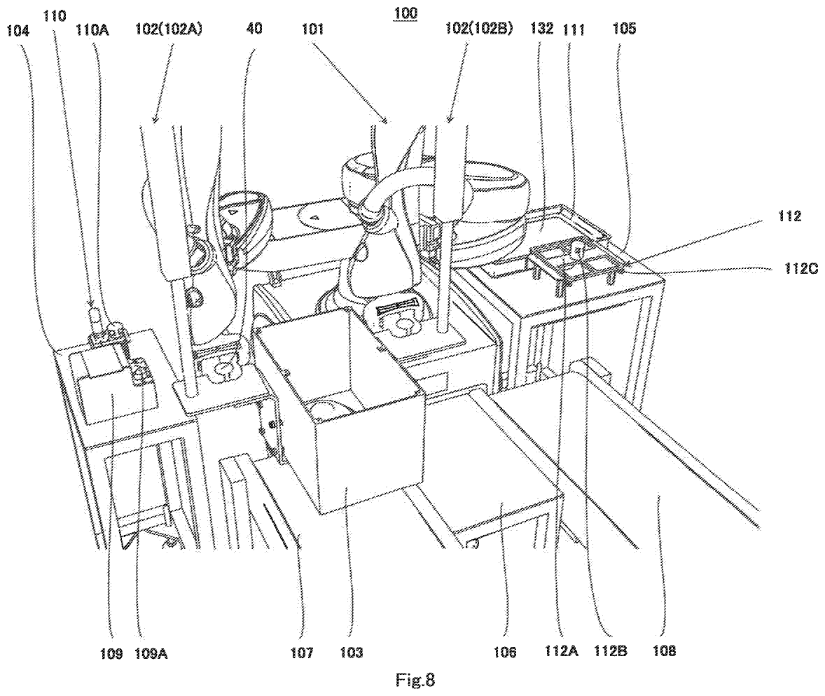

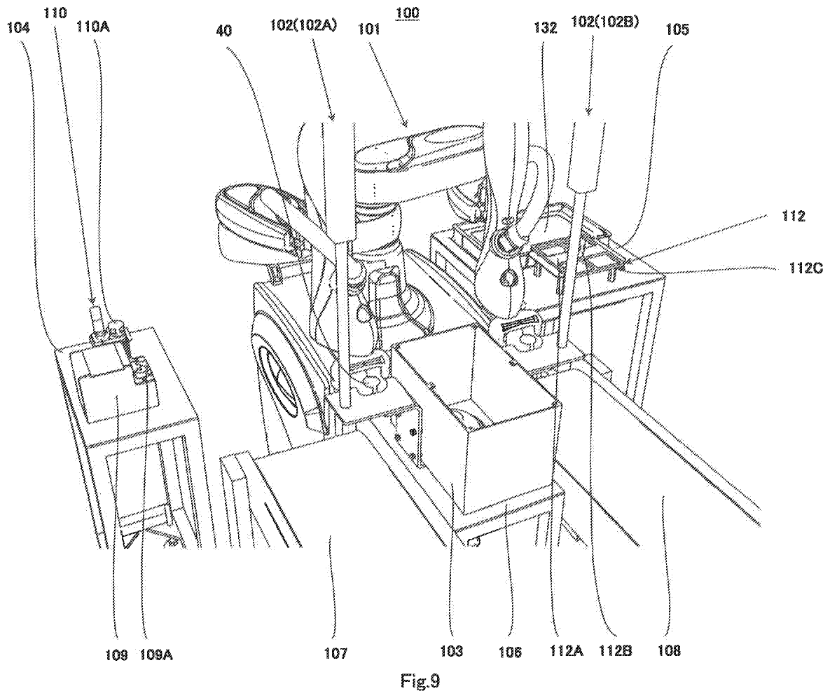

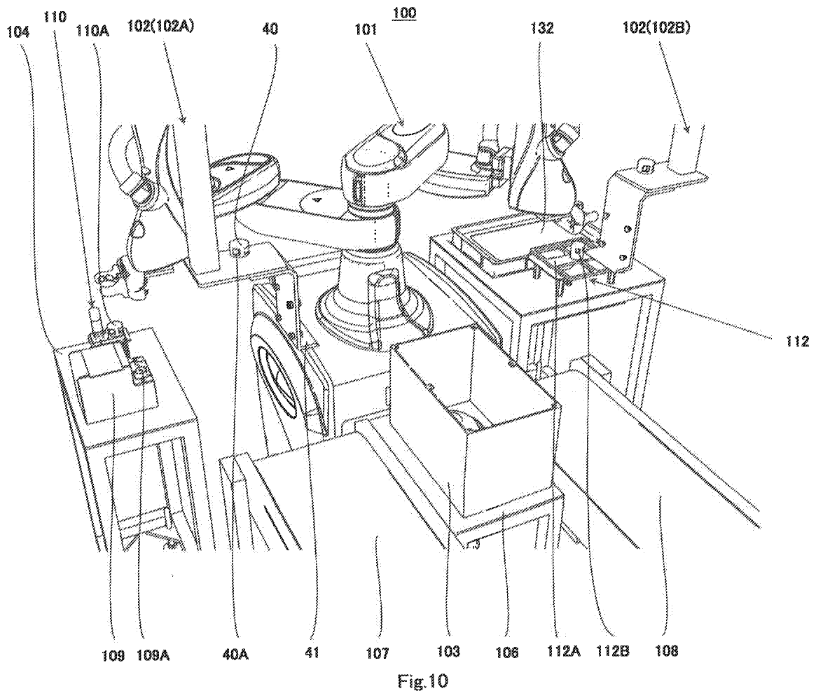

Specifically, FIG. 7 is a perspective view illustrating a state where the elevator of the transferring device lowers the to-be-gripped part. FIG. 8 is a perspective view illustrating a state where the first arm and the second arm of the robot grip the to-be-gripped parts. FIG. 9 is a perspective view illustrating a state where the robot and the transferring device collaboratively place the workpiece on the workbench. FIG. 10 is a perspective view illustrating a state where the first arm and the second arm of the robot release the to-be-gripped part, and the elevator of the transferring device raises the to-be-gripped part.

First, an instruction information indicating that operation to place the workpiece 103 conveyed from the first belt conveyor 107 on to the workbench 106 is to be executed is inputted by an operator through an input device (not illustrated) into the control device 14. Then, as illustrated in FIG. 1, the workpiece 103 is conveyed from the first belt conveyor 107 to a given position.

Then, as illustrated in FIG. 6, the control device 14 operates the elevator 35 so that the to-be-gripped part 40 of at least one of the first unit 102A and the second unit 102B is located at a given preset first position (Step S101; refer to FIG. 7).

Here, as for the first unit 102A, the first given position is a position at which first contact surfaces 51A of the pawl portions 10A of the first arm 13A contact the outer circumferential surface of the to-be-gripped parts 40 of the first unit 102A, and are able to hold (grip) the to-be-gripped parts 40, respectively. Moreover, as for the second unit 102B, the first given position is a position at which first contact surfaces of the pawl portions 10B of the second arm 13B contact the outer circumferential surface of the to-be-gripped part 40 of the second unit 102B, and are able to hold (grip) the to-be-gripped parts 40. The first position can suitably be set according to the dimensions, movable range, etc. of the robot 101 and the transferring device 102.

Note that the control device 14 may operate the elevator 35 of the first unit 102A and the elevator 35 of the second unit 102B so that the to-be-gripped part 40 of the first unit 102A and the to-be-gripped part 40 of the second unit 102B move simultaneously to the first positions. Moreover, after moving one of the to-be-gripped parts 40 to the first position, the control device 14 may operate the elevators 35 so that the other to-be-gripped part 40 moves to the first position.

Next, the control device 14 operates the first arm 13A and the second arm 13B so that the pair of to-be-gripped parts 40 are gripped by the first grip part (pawl portions 10A) and the second grip part (pawl portions 10B), respectively (Step S102). At this time, the control device 14 operates the first arm 13A so that the first contact surfaces 51A at the tip-end parts of the pawl portions 10A contact the recesses 40A of the to-be-gripped part 40. Similarly, the control device 14 operates the second arm 13B so that the first contact surfaces at the tip-end parts of the pawl portions 10B contact the recesses 40A of the to-be-gripped part 40.

Next, the control device 14 acquires image information imaged by an imaging device (not illustrated), and then acquires positional information on the workpiece 103 placed on the first belt conveyor 107, from the acquired image information (Step S103).

Next, based on the positional information on the workpiece 103 acquired at Step S103, the control device 14 operates the first arm 13A and the second arm 13B so that the holding part 41 of the first unit 102A and the holding part 41 of the second unit 102B oppose to each other on both sides of the workpiece 103 (Step S104). At this time, the control device 14 may operate the first arm 13A and the second arm 13B so that the tip-end part of the third portion 41C of the first unit 102A and the tip-end part of the third portion 41C of the second unit 102B may oppose to each other on both sides of the workpiece 103.

Next, the control device 14 operates the first arm 13A so that the tip-end part of the third portion 41C of the holding part 41 of the first unit 102A is inserted into a space between a lower surface of the workpiece 103 and an upper surface of the first belt conveyor 107, and operates the second arm 13B so that the tip-end part of the third portion 41C of the holding part 41 of the second unit 102B is inserted into a space between the lower surface of the workpiece 103 and the upper surface of the first belt conveyor 107 (Step S105). Then, the control device 14 operates the first arm 13A or the second arm 13B so that the holding part 41 of the first unit 102A and the holding part 41 of the second unit 102B approach each other (Step S106).

Thus, the third portion 41C of the first unit 102A and the third portion 41C of the second unit 102B are inserted into the space between the workpiece 103 and the upper surface of the first belt conveyor 107, and the workpiece 103 is placed on the third portion 41C of the holding part 41.

Next, the control device 14 operates the first arm 13A and the second arm 13B so that the workpiece 103 is located above the workbench 106 (Step S107; refer to FIG. 8). At this time, the control device 14 operates the first arm 13A and the second arm 13B so that the holding part 41 of the first unit 102A and the holding part 41 of the second unit 102B transfer the workpiece 103 while sandwiching the workpiece 103 therebetween and supporting the lower surface of the workpiece 103.

Thus, even if the workpiece 103 has a complicated shape, the pair of holding parts 41 can transfer the workpiece 103, while supporting the lower surface of the workpiece 103, by sandwiching the workpiece 103 therebetween. Therefore, when conveying a plurality of kinds of workpieces 103, the workpieces 103 can be conveyed, without changing the holding part 41 of the transferring device 102 to jigs corresponding to the kinds of workpieces 103.

Next, the control device 14 operates the first arm 13A and the second arm 13B so that the workpiece 103 is placed on the workbench 106 (Step S108; refer to FIG. 9).

Specifically, the control device 14 operates the first arm 13A and the second arm 13B so that the lower surface(s) of the third portion 41C of the first unit 102A and/or the third portion 41C of the second unit 102B contact the upper surface of the workbench 106.

Then, the control device 14 operates the first arm 13A or the second arm 13B so that one of the holding part 41 of the first unit 102A and the holding part 41 of the second unit 102B separates from the other holding part 41 to release the hold of the workpiece 103, and then operates the first arm 13A or the second arm 13B so that the other holding part 41 releases the hold of the workpiece 103. Alternatively, the control device 14 may operate the first arm 13A and the second aim 13B so that the holds of the workpiece 103 by the holding part 41 of the first unit 102A and the holding part 41 of the second unit 102B are released simultaneously.

Next, the control device 14 operates the elevator 35 so that the to-be-gripped part 40 of at least one of the first unit 102A and the second unit 102B is located at a second given preset position (Step S109; refer to FIG. 10), and ends this program.

Here, the second given position is a position at which the to-be-gripped part 40 is evacuated in the up-and-down direction, and a position at which the robot 101 does not need to operate each part which constitutes the transferring device 102 so as to avoid the to-be-gripped part 40. The second position is located outside the operating range of the robot 101, and may suitably be set within the operating range of the transferring device 102.

As the second position, it may be a position when the to-be-gripped part 40 moves the highest, for example. Alternatively, as the second position, it may be a position where the to-be-gripped part 40 does not disturb the work, for example, if the next work of the robot 101 (an attachment work of a lid of the speaker) is decided beforehand, as will be described later.

Note that the control device 14 may operate the elevator 35 of the first unit 102A and the elevator 35 of the second unit 102B so that the to-be-gripped part 40 of the first unit 102A and the to-be-gripped part 40 of the second unit 102B move simultaneously to the second positions. Alternatively, the control device 14 may operate the elevators 35 so that one of the to-be-gripped parts 40 moves to the second position, and the other to-be-gripped part 40 then moves to the second position.

Alternatively, the control device 14 may operate the first arm 13A and the second arm 13B so that they are located at given preset positions (initial positions), and then end this program. Further, the control device 14 may output information indicating that this program is ended (for example, an image, sound, light, etc.) from an output unit (for example, a tablet, a speaker, etc.).

Next, operation after the robot 101 and the transferring device 102 collaboratively transfer (place) the workpiece 103 onto the workbench 106 is described with reference to FIGS. 1 to 5 and 10 to 14.

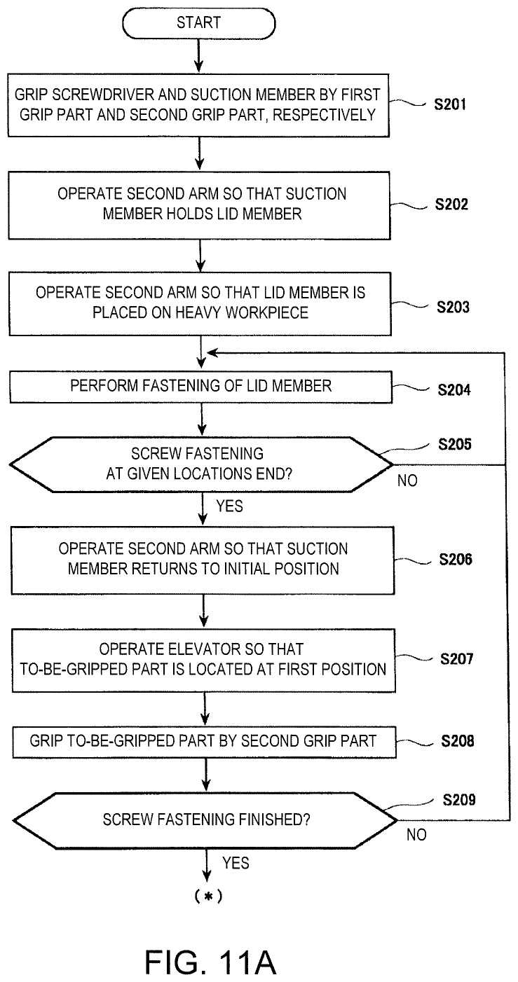

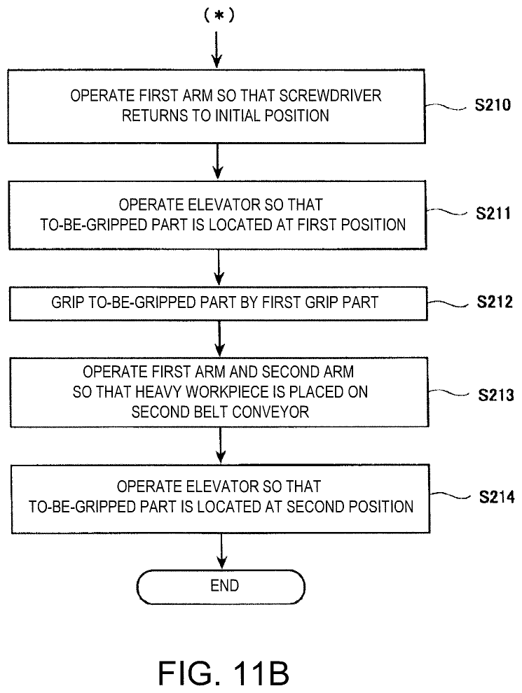

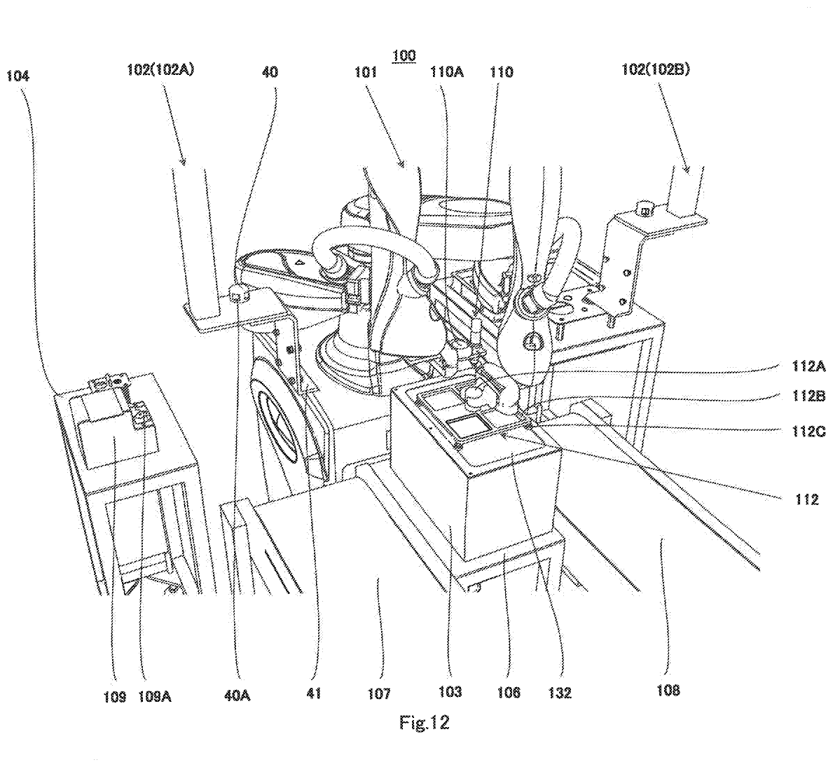

FIGS. 11A and 11B are a flowchart illustrating another example of the operation of the transferring system according to Embodiment 1. FIGS. 12 to 14 are schematic views illustrating states of the robot and the transferring device when the transferring system operates according to the flowchart illustrated in FIGS. 11A and 11B.

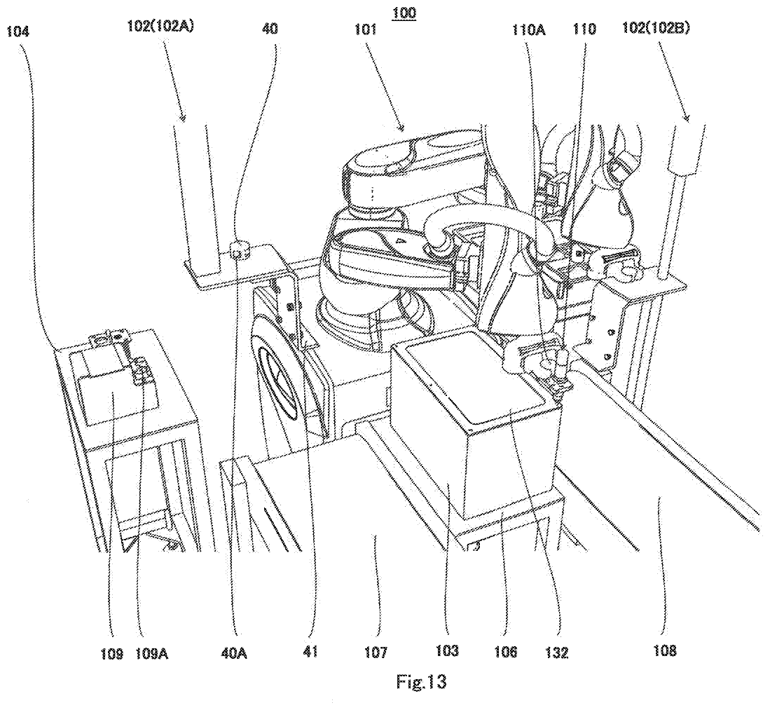

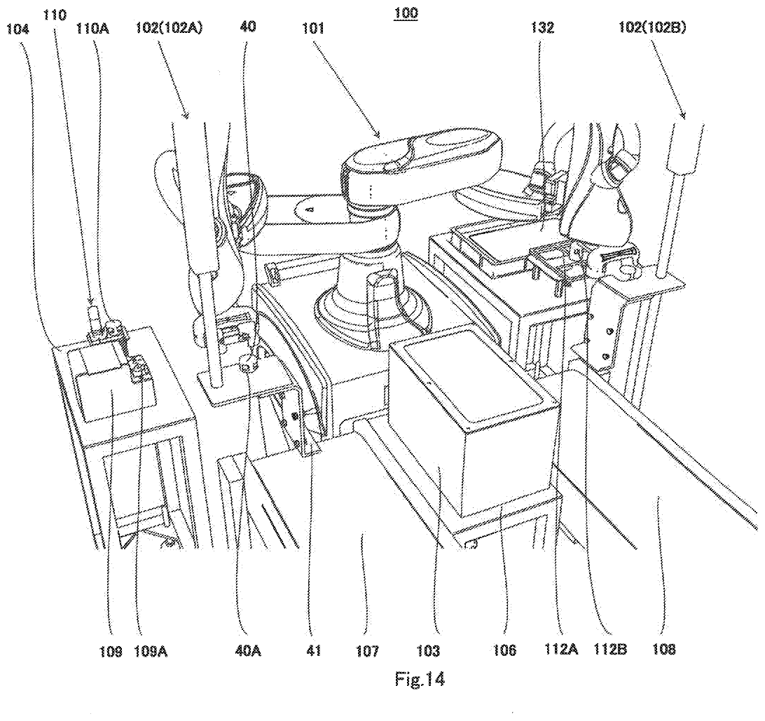

Specifically, FIG. 12 is a perspective view illustrating a state where the first arm of the robot holds the screwdriver, the second arm of the robot holds the suction member, and the first arm of the robot fastens the lid member to the speaker with screw(s). FIG. 13 is a perspective view illustrating a state where the first arm of the robot holds the screwdriver and fasten the lid member with screws, and the second arm of the robot grips the to-be-gripped part. FIG. 14 is a perspective view illustrating a state where the elevator of the transferring device lowers the to-be-gripped part.

First, as illustrated in FIG. 10, the robot 101 collaborates with the transferring device 102 to place the workpiece 103 on the workbench 106, and then releases the to-be-gripped part 40. At this time, instruction information for performing operation to place the workpiece 103 on the second belt conveyor 108 after the lid member 132 is fastened to the workpiece 103 with the screws is inputted into the control device 14 by the operator through the input device (not illustrated).

Alternatively, instruction information for performing operation to fasten the lid member 132 to the workpiece 103 with the screws, and place the workpiece 103 on the second belt conveyor 108 after the workpiece 103 conveyed from the first belt conveyor 107 is placed on the workbench 106 is inputted into the control device 14 by the operator through the input device (not illustrated).

Then, as illustrated in FIG. 11A, the control device 14 operates the first arm 13A and the second arm 13B so that the screwdriver 110 and the suction member 112 are gripped by the first grip part (pawl portions 10A) and the second grip part (pawl portions 10B), respectively (Step S201).

At this time, the control device 14 operates the first arm 13A so that the first contact surfaces 51A of the tip-end parts of the pawl portions 10A contact the recesses of the to-be-gripped parts 110A. Moreover, the control device 14 operates the second arm 13B so that the first contact surfaces of the tip-end parts of the pawl portions 10B contact the recesses of the to-be-gripped part 112B of the suction member 112. Thus, the suction member 112 is connected to the vacuum generator 25.

Next, the control device 14 operates the second arm 13B so that the suction member 112 holds the lid member 132 (Step S202). Specifically, the control device 14 operates the vacuum generator 25, brings the suction part 112C of the suction member 112 into contact with the upper surface of the lid member 132, and causes the suction part 112C to suck and hold the lid member 132.

Next, the control device 14 operates the second arm 13B so that the lid member 132 is placed on the workpiece 103 (Step S203). Then, the control device 14 performs the fastening of the lid member 132 with the screws (Step S204). Specifically, the control device 14 uses the screws 109A fed from the screw feeder 109, and fastens the lid member 132 to the workpiece 103 with the screws by the screwdriver 110 which the first arm 13A grips.

Next, the control device 14 determines whether the screw fastening at given locations is ended (Step S205). Note that the given locations may suitably be set based on locations and number of the screw fastening to the workpiece 103. As the given locations, for example, they may be one location, or may be two or three locations, as long as the lid member 132 does not move with respect to the workpiece 103 when the suction member 112 releases the suction and hold of the lid member 132.

If the control device 14 determines that the screw fastening at the given locations has not been finished (No at Step S205), it returns to Step S204, and repeats the processings illustrated at Steps S204 and 5205 until the screw fastening at the given locations is finished. On the other hand, if the control device 14 determines that the screw fastening at the given locations is finished (Yes at Step S205), it executes processing illustrated at Step S206.

At Step S206, the control device 14 operates the second arm 13B so that the suction member 112 returns to an initial position. Note that, as illustrated in FIG. 1 etc., the initial position of the suction member 112 is a location in front of the tray 111 on the second table 105 in Embodiment 1.

Then, the control device 14 operates the elevator 35 of the second unit 102B so that the to-be-gripped part 40 of the second unit 102B is located at the first position (Step S207), and operates the second arm 13B so that the second grip part grips the to-be-gripped part 40 of the second unit 102B (Step S208).

Next, the control device 14 determines whether the fastening of the lid member 132 with the screws is finished (Step S209). If the control device 14 determines that the fastening of the lid member 132 with the screws has not been finished (No at Step S209), it returns to Step S204, and repeats processings at Steps S204-S209 until the fastening of the lid member 132 with the screws is finished. On the other hand, if the control device 14 determines that the fastening of the lid member 132 with the screws is finished (Yes at Step S209), it executes processing illustrated at Step S210.

At Step S210, as illustrated in FIG. 11B, the control device 14 operates the first arm 13A so that the screwdriver 110 returns to the initial position. Note that, as illustrated in FIG. 1 etc., the initial position of the screwdriver 110 is a rear part of the screw feeder 109 on the first table 104.

Next, the control device 14 operates the elevator 35 of the first unit 102A so that the to-be-gripped part 40 of the first unit 102A is located at the first position (Step S211), and operates the first arm 13A so that the first grip part grips the to-be-gripped part 40 of the first unit 102A (Step S212).

Next, the control device 14 operates the first arm 13A and the second arm 13B so that the workpiece 103 to which the lid member 132 is attached is placed on the second belt conveyor 108 (Step S213). Specifically, the control device 14 executes similar processings to Steps S103-S108 described above.

Next, the control device 14 operates the elevator 35 (Step S213) so that the to-be-gripped part 40 of at least one of the first unit 102A and the second unit 102B is located at the second given preset position, and ends this program.

Note that the control device 14 may operate the elevator 35 of the first unit 102A and the elevator 35 of the second unit 102B so that the to-be-gripped part 40 of the first unit 102A and the to-be-gripped part 40 of the second unit 102B are simultaneously moved to the second position. Moreover, the control device 14 may operate the elevators 35 so that one of the to-be-gripped parts 40 moves to the second position, and the other to-be-gripped part 40 then moves to the second position.

Moreover, the control device 14 may operate the first arm 13A and the second arm 13B so that they are located at a given preset position (initial position), and end this program. Further, the control device 14 may output information indicating that this program is ended (for example, an image, sound, light, etc.) from the output unit (for example, a tablet, a speaker, etc.).

In the transferring system 100 according to Embodiment 1 configured in this way, when the robot 101 and the transferring device 102 collaboratively transfer the workpiece 103, the control device 14 operates the elevator 35 so that the to-be-gripped part 40 moves (descends) to the first position. Thus, in order for the robot 101 to grip the to-be-gripped part 40, it is not necessary to detect the position of the to-be-gripped part 40, and then operate the first arm 13A and the second arm 13B. Therefore, the time before the robot 101 starts the work to the workpiece 103 can be shortened.

Moreover, in the transferring system 100 according to Embodiment 1, since the control device 14 which controls the operation of the robot 101 executes the control of the transferring device 102, the operation of the robot 101 and the operation of the transferring device 102 can be performed in parallel.

Further, in the transferring system 100 according to Embodiment 1, the first arm 13A and the second arm 13B are operated so that the holding part 41 of the first unit 102A and the holding part 41 of the second unit 102B transfer the workpiece 103, while supporting the lower surface of the workpiece 103 and sandwiching the workpiece 103 therebetween.

Therefore, even if the workpiece 103 has a complicated shape, the pair of holding parts 41 can transfer the workpiece 103, while supporting the lower surface of the workpiece 103 and sandwiching the workpiece 103 therebetween. Therefore, even if a plurality of kinds of workpieces 103 are conveyed, the workpieces 103 can be transferred, without changing the holding part 41 of the transferring device 102 into the jigs corresponding to the kinds of workpieces 103.

It is apparent for a person skilled in the art that many improvements or other embodiments of the present disclosure are possible from the above description. Therefore, the above description is to be interpreted only as illustration, and it is provided in order to teach a person skilled in the art the best mode to implement the present disclosure. The details of the structure and/or the functions may be changed substantially, without departing from the spirit of the present disclosure.

### INDUSTRIAL APPLICABILITY

The transferring system and the method of operating the same according to the present disclosure are useful in the field of industrial robots because, when the workpiece is held by the pair of holding parts, the elevator automatically moves (lowers) the to-be-gripped part to the first position, and therefore the time before the robot starts the work to the workpiece can be shortened.

### DESCRIPTION OF REFERENCE CHARACTERS

5a First Link
5b Second Link
8A Stationary Portion
9A Main Body Portion
10A Pawl Portion
10B Pawl Portion
12 Carrier
13A First Arm
13B Second Arm
14 Control Device
14a Processor
14b Memory
14c Servo Controller
15A First Arm Part
15B Second Arm Part
16 Base Shaft
17A First Wrist Part
17B Second Wrist Part
18A First Hand Part
18B Second Hand Part
20A First Attaching Part
20B Second Attaching Part
25 Vacuum Generator
26 Piping
31 Pedestal
32 Pillar Member
33 First Arm
34 Second Arm
35 Elevator
36 First Casing
37 Second Casing
38 Third Casing
39 Plate Member
40 To-be-gripped Part
40A Recess
41 Holding Part
41A First Portion
41B Second Portion
41C Third Portion
51A First Contact Surface
100 Transferring System
101 Robot
102 Transferring Device
102A First Unit
102B Second Unit
103 Workpiece
104 First Table
105 Second Table
106 Workbench
107 First Belt Conveyor
108 Second Belt Conveyor
109 Screw Feeder
109A Screw
110 Screwdriver
110A To-be-gripped Part
111 Tray
112 Suction Member
112A First Plate Member
112B To-be-gripped Part
112C Suction Part
132 Lid Member

1. A transferring system, comprising:
a robot including a first arm having a first grip part and a second arm having a second grip part;
a transferring device including a pair of to-be-gripped parts, a pair of holding parts configured to hold a workpiece, and an elevator configured to ascend and descend the holding part; and
a control device configured to control the robot and the transferring device,
wherein the control device operates the elevator so that the to-be-gripped parts move to a first position that is a position at which the first grip part or the second grip part is able to grip the to-be-gripped parts, when causing the pair of holding parts to hold the workpiece.

2. The transferring system of claim 1, wherein the control device operates the robot so that the first grip part grips one of the to-be-gripped parts, the second grip part grips the to-be-other grip part, and the pair of holding parts then hold and transfer the workpiece.

3. The transferring system of claim 2, wherein the control device operates the robot so that the pair of holding parts move so as to oppose to each other on both sides of the workpiece, and then scoop up the workpiece.

4. The transferring system of claim 2, wherein the control device operates the robot so that the hold of the to-be-gripped part is released after the workpiece is transferred, and then operates the elevator so that the to-be-gripped part moves to a second position that is an evacuating position of the to-be-gripped part.

5. A method of operating a transferring system provided with a robot including a first arm having a first grip part and a second arm having a second grip part, the transferring system being further provided with a transferring device including a pair of to-be-gripped parts, a pair of holding parts configured to hold a workpiece, and an elevator configured to ascend and descend the holding parts, the method comprising the steps of:
(A) operating the elevator so that the to-be-gripped parts move from a first position that is an evacuating position of the to-be-gripped part to a second position that is a position at which one of the first grip part and the second grip part is able to grip the to-be-gripped part.

6. The method of claim 5, further comprising (B) operating the robot so that the first grip part grips one of the to-be-gripped parts, the second grip part grips the to-be-other grip part, and the pair of holding parts then hold and transfer the workpiece.

7. The method of claim 6, wherein (B) includes causing the robot to operate the first arm and the second arm so that the pair of holding parts oppose to each other on both sides of the workpiece, and then scoop up the workpiece.

8. The method of claim 6, further comprising (C), after (B), operating the robot so that the hold of the to-be-gripped part is released, and then operating the elevator so that the to-be-gripped part moves to a second position that is an evacuating position of the to-be-gripped part.
